(19) United States
(12) Patent Application Publication
(10) Pub. No.: US 2004/0100641 A1
(43) Pub. Date: May 27, 2004

(54) Wireless click-and-deliver camera system

(76) Inventor: Glenn Paul, Titusville, NJ (US)

Correspondence Address: Richard C Woodbridge, Synnestvedt Lechner & Woodbridge, PO Box 592, Princeton, NJ, 08542-0592, US

(21) Appl. No.: 10/468,323

(22) PCT Filed: Feb. 20, 2002
(86) PCT No.: PCT/US02/05036

(51) Int. Cl. G06F 15/00; H04N 1/00

(52) U.S. Cl. 358/1.2; 358/1.15; 358/402

(57) ABSTRACT

This invention relates to a system and method (FIG. 1) for taking digital pictures, transmitting the pictures directly from a digital camera (10) to a remote location (14) via wireless technology (12), storing the images so they can be viewed remotely (16), processing the pictures (18) to produce prints (20), and delivering the printed pictures to the person who took them or to a designee (22).

### CROSS REFERENCE TO RELATED APPLICATIONS

This application claims priority from U.S. provisional application No. 60/269,837 filed on Feb. 20, 2001.

### BACKGROUND OF THE INVENTION

1. Field of the Invention

This invention relates to a device and method for taking pictures, transmitting the pictures directly from a digital camera to a remote location via wireless technology, storing the images for viewing remotely and processing the pictures to produce prints, and delivering the printed pictures to the person who took them or to a designee.

2. Description of Related Art

Ever since the invention of the camera in the 1850's, it has been necessary for the photographer to take the picture by exposing an emulsion-based film to the image to be recorded and then taking the film either to a laboratory for developing or developing the film themselves. Later, film developing labs sprang up that would accept film from a photographer, develop the film and return the printed photographs. The film still had to be dropped off in person or sent by mail to the lab. The process was cumbersome, to say the least, for the average individual with a roll or two of film to be developed. It was out of the question for the average home photographer to invest in an expensive machine or the chemicals necessary to develop film at home. Thus the need to take the film to “get it developed” has been a necessary evil for over a century.

With the advent of charge-coupled devices (CCD's), digital cameras could now record an image electronically in digital form. The digital image could then be downloaded into a personal computer by physically connecting the imaging device to the computer and either processing it with a local printer connected to the PC, or the images could be sent to a central film processor to be printed out as photographs. Locally connected ink jet printer technology currently does an acceptable job of printing digital images, but images that are sent for central processing are generally superior because they can be enhanced by electronic image enhancing software to smooth the image and enhance the color. Also, central processing uses a mature digital-to-chemical photographic process that is lower cost and provides a longer “fade life” than typical inkjet printing: The user receives an actual photographic print like the one he or she has customarily purchased at the local drugstore.

The common theme in both of these imaging methods is that it is necessary to take a picture, and then make arrangements for the pictures to be either developed or printed and delivered. This often leads to a situation where images in the form of film or digital files would remain unprocessed until someone decided to take the film in for developing or send the digital images to a processing service.

The present invention eliminates both the need to bring the images to a processing lab to be processed or to process the images at home. The images are sent directly from the camera or other imaging device via wireless technology to a central processing station where they are digitally enhanced and printed, then sent to a predetermined destination. The images can be either sent automatically upon being recorded or the photographer can send them after they are reviewed.

### SUMMARY OF THE INVENTION

Briefly described, the invention comprises a digital imaging device such as a digital camera with a wireless transfer means like a wireless modem or satellite transmitter to transfer digital images to a remote processing location. The remote location can be connected to a computer network such as the Internet so as to allow the wireless transfer to be made from the imaging device to a local receiving station and then the images can be transferred via the computer network to the remote processing/storage location. The digital images can be enhanced through the use of digital image processing software to improve the clarity of the images, smooth the images, enlarge the images or enhance the color. The digital images may be accessed by the photographer via the computer network for review and approval of the final images. Prints may be sent to designated locations or e-mail invitations can be sent to people inviting them to view the images online. Various embodiments of the invention include a one-button digital imaging device that automatically transfers the images to the remote processing/storage facility and a two-button imaging device with a view screen that allows for prescreening of the images and only sends the image to the remote processing/storage facility when prompted to do so by the photographer. The invention may be more fully understood by reference to the following drawings.

### BRIEF DESCRIPTION OF THE DRAWINGS

FIG. 1 is a Schematic diagram of Wireless Click-and-Deliver Camera System.

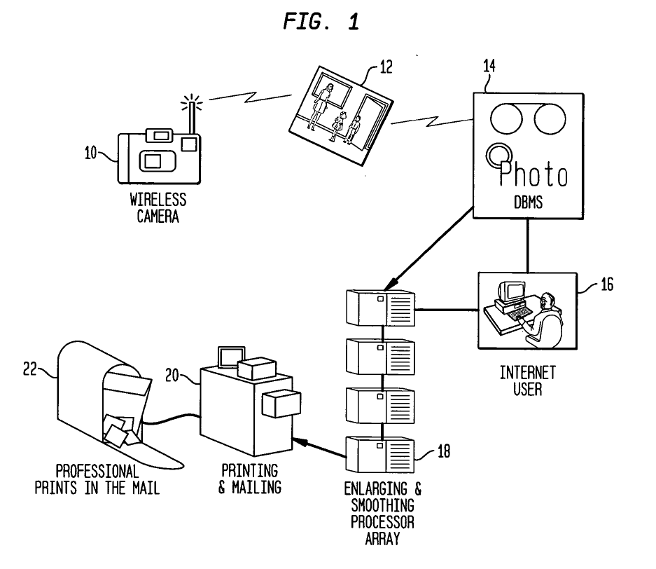

### DETAILED DESCRIPTION OF THE PREFERRED EMBODIMENT

During the course of this description like numbers will be used to identify like elements according to the different figures, which illustrate the invention.

A digital image is recorded using a digital imaging device such as a digital wireless camera (10). The digital wireless camera (10) includes a unique camera identification number that is transferred with each picture. Typically the camera takes a 1024×768 or 1800×1200 pixel image, which will be converted into a standard format such as JPEG. A built-in wireless modem is used to make a wireless digital photo transmission (12) of the image along with the unique identifying number to a Digital Photo Management System (DPMS)(14). The wireless transmission can be received by a local receiving station or satellite and then transmitted on the Internet.

The Digital Photo Management System (DPMS) (14) establishes virtual photo albums for owners of the wireless camera (10), and tracks the name, address, and customer preferences of each owner. Camera owners can establish their preferences via regular mail, Internet connection, or by calling customer service. Once a customer account is established, the (DPMS) recognizes a customer's incoming digital photos and treats them according to the customer's preferences. For instance, the photos may be automatically printed and mailed to one or several addresses; e-mail invitations to view the photos may be sent to multiple associates; or both. Camera owners who are Internet users (16) can also access the DPMS to view, print, download, add sound, or edit other attributes of the photo.

In a separate operation, the Enlarging and Smoothing Processor Array (ESPA) (18) prepares smaller images for printing as 4″×6″ photos. This array of micro-computers uses fractal math or other algorithms to enlarge smaller images so that they can produce acceptable 4″×6″ prints.

Integrated high-speed photo processing equipment (20) prints up to 1000 prints an hour for packaging and shipping directly to the customer or to a designated address (22).

Alternative embodiments of the invention may include a one-button wireless camera, which transmits every photo to the remote processing/storage facility for printing. Customers are protected from user error or theft by the ability to set limits on daily, weekly or monthly totals for printed photos. An account can be established to accept photos, and wait for an Internet session for printing approval. Another alternative embodiment includes a two-button camera in which the second button is pushed only when the photographer wishes to transmit a photo. Another alternative embodiment provides a second button and a view screen so that the photographer can review the images prior to sending them to the processing/storage facility.

While the invention has been described with reference to the preferred embodiment thereof, it will be appreciated by those of ordinary skill in the art that modifications can be made to the structure and elements of the invention without departing from the spirit and scope of the invention as a whole.

We claim that:

1. A wireless image transmission and processing system comprising:
a wireless digital imaging means comprising;
a digital imaging means;
a wireless transmission means for transmitting digital images;
a digital photo management system;
an enlarging and smoothing processor array; and, printing and mailing means for printing and mailing photographs to a predetermined location.

2. The system of claim 1 wherein said digital imaging means comprises a digital camera having a unique identification number.

3. The system of claim 2 wherein said wireless transmission means comprises a digital modem.

4. The system of claim 3 wherein said wireless transmission means further includes a satellite transmitter.

5. The system of claim 4 wherein said wireless transmission means further comprises: means for transmitting said unique identification number along with said digital images.

6. The system of claim 5 wherein said digital photo management system comprises:
storage means for storing digital photos;
tracking means for tracking customer data specific to an individual customer, storage means for storing customer preferences;
Internet connection means for allowing users to view said stored digital photos stored on said storage means; and,
recognizing means for recognizing an individual customer's incoming digital photos and processing said photos according to said stored customer preferences.

7. The system of claim 6 wherein said enlarging and smoothing processor array comprises a microprocessor.

8. The system of claim 7 wherein said enlarging and smoothing processor array further comprises:
means for processing digital images through the application of mathematical algorithms to enlarge digital images.

9. The system of claim 8 wherein said mathematical algorithms comprise fractal image processing.

10. The system of claim 9 wherein said printing means comprises an automatic printing and mailing apparatus.

11. A method for wireless image transmission and processing comprising:
(a) producing a digital image;
(b) transmitting said digital image via wireless transmission means to a remote location for processing;
(c) transmitting a unique identifying number along with each digital image;
(d) storing said digital images using a digital photo management system;
(e) processing said digital images using said digital photo management system;
(f) processing said digital images using an enlarging and smoothing processor array to produce photographs; and,
(g) printing and mailing said photographs to a predetermined location.

12. The method of claim 11 wherein said digital images are produced with a digital camera.

13. The method of claim 12 wherein said wireless transmission means comprises a digital modem.

14. The method of claim 13 wherein said wireless transmission means further includes a satellite transmitter.

15. The method of claim 14 wherein said digital photo management system comprises:
storage means for storing digital photos;
tracking means for tracking customer data specific to an individual customer;
storage means for storing customer preferences;
Internet connection means for allowing users to view said stored digital photos stored on said storage means; and,
Recognizing means for recognizing an individual customer's incoming digital photos and processing said photos according to said stored customer preferences.

16. The method of claim 15 wherein said enlarging and smoothing processor array comprises a microprocessor.

17. The method of claim 16 wherein said enlarging and smoothing processor array further comprises:
means mathematical algorithm to enlarge digital images.

18. The method of claim 17 wherein said mathematical algorithm comprises fractal image processing.

19. The method of claim 18 wherein said printing means comprises an automatic printing and mailing apparatus.
